(19) United States
(12) Patent Application Publication
(10) Pub. No.: US 2010/0090796 A1
(43) Pub. Date: Apr. 15, 2010

(54) MOVABLE BARRIER SYSTEM ADAPTED TO TRANSMIT DIAGNOSTIC INFORMATION TO A REMOTE DEVICE

(76) Inventors: Daniel Perez, Foothill Ranch, CA (US); Pezhman Karimi, Laguna Niguel, CA (US)

Correspondence Address: JAFARI LAW GROUP, P.C., 801 N. PARKCENTER DRIVE, SUITE 220, SANTA ANA, CA, 92705, US

(21) Appl. No.: 12/249,733

(22) Filed: Oct. 10, 2008

(51) Int. Cl. G05B 19/00; H04B 7/00; H04M 1/00

(52) U.S. Cl. 340/5.7; 455/41.2; 455/556.1

(57) ABSTRACT

The invention is a movable barrier system with wireless connectivity to a remote device in close proximity. More particularly, an apparatus in accordance with the present invention comprises of a movable barrier, an operator adapted to control movement of the movable barrier, and a wireless peer-to-peer interface adapted to transmit diagnostic information to a remote device in response to a command instruction received from said remote device. When movable barrier system receives a command instruction from remote device, it may perform self-diagnostic tests on specific sub-components and externally connected devices. After obtaining test results, movable barrier system transmits diagnostic information back to remote device.

### TECHNICAL FIELD OF THE INVENTION

The present invention relates generally to a movable barrier system adapted to communicate with a remote device, and more specifically, to a movable barrier system including a wireless peer-to-peer interface adapted to transmit diagnostic information to a remote device in response to a command instruction received from said remote device.

### COPYRIGHT & TRADEMARK NOTICE

A portion of the disclosure of this patent application may contain material that is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and shall not be construed as descriptive or to limit the scope of this invention to material associated only with such marks.

### BACKGROUND OF THE INVENTION

Movable barriers, such as garage doors, sliding gates, windows, etc. may be manually operated. Many movable barriers are connected to movable barrier operators, powered devices that, when activated, move the barrier. Movable barrier operators increase the utility and ease of use of a movable barrier by decreasing the amount of exertion required on the part of the user.

While movable barrier operators increase utility and ease of use of a movable barrier, the addition of a multiple mechanical and electrical parts also increases the complexity of maintenance required. With complex movable barrier systems, proper instrumentation to test each individual sub-component may be necessary. As such, a technician may require multiple tools and instruments. Consequently, diagnosis of a problem in a complex movable barrier system may be increasingly difficult or expensive. If, however, a movable barrier system could perform self-diagnostics, maintenance and troubleshooting would become much simpler. Therefore, there is a need in the art for a movable barrier system that can perform self-diagnostic tests.

In the current state of the art, troubleshooting a movable gate operator often requires manual inspection by a technician. Manual access to a movable gate operator, however, may not always be practical. As such, there is a need in the art for a movable barrier system with the capability to transmit diagnostic information and test results to a remote device in close proximity of said movable barrier system.

Manufacturers have attempted to combat the issues of modern movable barrier systems in a number of ways. Some manufacturers have added devices that monitor the physical status of the movable barrier. Others have added DTMF capabilities to the movable barrier operator for a remote diagnostic. Some have added audible sound capability to the movable barrier operator for diagnostic purposes. Yet others have implemented Bluetooth capability for control and access management. None of these attempts, however, address all the issues with current movable barrier systems.

There is a need in the art for a movable barrier system adapted to transmit diagnostic information to a remote device. Specifically, there is a need for a movable barrier system that may transmit diagnostic information to a remote device in response to a command instruction received from the remote device. It is to these ends that the present invention has been developed.

### SUMMARY OF THE INVENTION

To minimize the limitations in the prior art, and to minimize other limitations that will be apparent upon reading and understanding the present specification, the present invention describes a movable barrier system adapted to transmit diagnostic information to a remote device, such as a cellular phone or personal digital assistant, in response to a command instruction received from the remote device.

An apparatus in accordance with the present invention comprises a movable barrier, an operator adapted to control movement of the movable barrier, and a wireless peer-to-peer interface adapted to transmit diagnostic information to a remote device in response to a command instruction received from said remote device.

Additionally, an apparatus in accordance with the present invention may comprise of a plurality of movable barrier subsystems and a wireless peer-to-peer interface adapted to transmit diagnostic information from at least one of the movable barrier subsystems in response to a control instruction received from a remote device to said remote device.

Moreover, the present invention also discloses a remote device comprising of a user interface, a wireless peer-to-peer interface, and a processor adapted to receive a first command from a user via the user interface, transmit a second command to a movable barrier system via the wireless peer-to-peer interface, and receive diagnostic information from the movable barrier system via the wireless peer-to-peer interface.

It is an objective of the present invention to provide a movable barrier system with wireless connectivity to a remote device in close proximity.

It is another objective of the present invention to provide a user with remote access to a movable barrier system for diagnostic purposes.

It is yet another objective of the present invention to provide a movable barrier system that can perform diagnostic tests on sub-components and externally connected devices to said movable barrier system.

Finally, it is yet another objective of the present invention to provide a movable barrier system that can transmit diagnostic information and test results to remote device.

These and other advantages and features of the present invention are described herein with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 illustrates a block diagram of an exemplary embodiment of a movable barrier system in which the movable barrier operator is adapted to control movement of a movable barrier, and a wireless peer-to-peer interface is adapted to transmit diagnostic information to a remote device in response to a control instruction received from the remote device.

FIG. 2(a) illustrates a block diagram of an exemplary embodiment of a movable barrier system connected to compatible external devices.

FIG. 2(b) illustrates a flow chart of the diagnostic process utilized by the movable barrier system in accordance to one embodiment of the present invention.

FIG. 3(a) illustrates a block diagram of an exemplary embodiment of the internal components of a remote device.

FIG. 3(b) illustrates a flow chart of the diagnostic information retrieval process utilized by the wireless remote device in one embodiment of the present invention.

FIG. 4(a) illustrates a block diagram of an exemplary embodiment of a plurality of movable barrier subsystems and a wireless peer-to-peer interface adapted to transmit diagnostic information to a remote device in response to a control instruction received from the remote device.

FIG. 4(b) illustrates a flow chart of the general diagnostic process utilized by a plurality of movable barrier subsystems in accordance to one embodiment of the present invention.

### DETAILED DESCRIPTION OF THE DRAWINGS

In the following discussion that addresses a number of embodiments and applications of the present invention, reference is made to the accompanying drawings that form a part hereof, where depictions are made, by way of illustration, of specific embodiments in which the invention may be practiced. It is to be understood that other embodiments may be utilized and changes may be made without departing from the scope of the present invention.

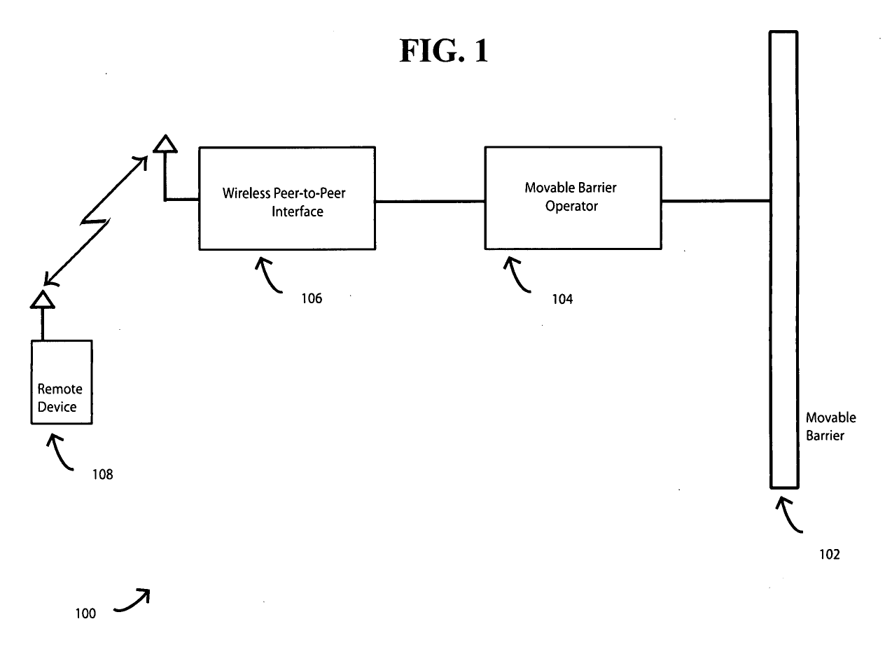

FIG. 1 illustrates a block diagram of an exemplary embodiment of a movable barrier system in which a movable barrier operator is adapted to control movement of a movable barrier, and a wireless peer-to-peer interface is adapted to transmit diagnostic information to a remote device in response to a control instruction received from the remote device.

FIG. 1 shows movable barrier system 100, which includes a movable barrier 102, movable barrier operator 104, and wireless peer-to-peer interface 106, which is adapted to transmit diagnostic information to, in response to a command received from, a remote device 108 through peer-to-peer transmissions 110. Movable barrier system 100 is designed to provide the functionality of a movable barrier 102 in conjunction with movable barrier operator 104, but to additionally provide automatic wireless diagnostic and status information retrieval to a remote device 108 in close proximity to movable barrier system 100.

Movable barrier 102 is an object designed to obstruct an opening in its closed position. Movable barrier 102 may be moved to an open or partially open position, thereby not obstructing or only partially obstructing said opening. Movable barrier 102 may be a door or window for a small entity (i.e. a vehicle), or a gate for a large entity (i.e. a building). In various embodiments, movable barrier 102 may swing, slide, pivot, fold or roll. These examples should not limit the scope as to what may constitute movable barrier 102 or limit its motion possibilities.

Movable barrier operator 104 may be any machine or system that controls the movement of movable barrier 102. Movable barrier operator 104 may move movable barrier 102 to its open position, its closed position, or to any position in between. Movable barrier operator 104 may also start or stop movement of movable barrier 102 at any point along the movement track of movable barrier 102. In an exemplary embodiment where movable barrier 102 is a horizontally sliding gate, movable barrier operator 104 may control the horizontal sliding motion of movable barrier 102. In another exemplary embodiment where movable barrier 102 is an upward swinging garage door, movable barrier operator 104 may control the pivot swinging motion of movable barrier 102.

Wireless peer-to-peer interface 106 utilizes the Bluetooth wireless protocol. Wireless peer-to-peer interface 106 is designed for short-range data transmissions between movable barrier system 100 and remote device 108. Wireless peer-to-peer interface 106 is adapted to receive a command from remote device 108 and to transmit diagnostic information results to remote device 108. In the functionality of an exemplary embodiment, when wireless peer-to-peer interface 106 receives a command from remote device 108, movable barrier system 100 carries out the command, and wireless peer-to-peer interface 106 then transmits diagnostic test results to remote device 108 (discussed in detail below).

Remote device 108 may be any device that is Bluetooth enabled. Examples of such devices include cell phones, personal digital assistants, and notebook computers. This list, however, should not limit the scope as to what may constitute remote device in this disclosure.

Wireless peer-to-peer connectivity between movable barrier system 100 and a remote device 108 provides a number of benefits to a user. It would be advantageous for an operator of movable barrier system 100 to be able to check diagnostic information in situations of malfunction, as well as for routine maintenance and repair. Additionally, wireless peer-to-peer connectivity to movable barrier system 100 allows for ease of access to the user when manual access to movable barrier system 100 may be difficult or impractical.

Remote device 108 may transmit command instructions to wireless peer-to-peer interface 106 of movable barrier system 100 and may also receive diagnostic information and test results from movable barrier system 100. The commands transmitted by remote device 108 to movable barrier system 100 may include requests for diagnostic tests on specific devices, or a request for diagnostic information on all system parts and functions.

Remote device 108 may also transmit changes or alterations to system settings for movable barrier system 100, or may include control instructions to movable barrier operator 104 to perform on movable barrier 102. Control instructions include commands to open, close, and to start or stop movement of movable barrier 102. This list of commands, however, should not limit the scope as to what functions remote device 108 may perform in the present invention.

Remote device 108 may also, after reception of diagnostic information form movable barrier system 100, have the capability of transmitting said diagnostic information to a third party. Some examples of methods of data transfer of diagnostic information may include text messaging, email and email attachments. The capability to transfer received diagnostic information to a third party increases utility of movable barrier system 100 for the user and may expedite maintenance and repair work. For example, should a technician transfer diagnostic information through remote device 108 to the manufacturer of movable barrier system 100, the manufacturer may provide technician with valuable information to troubleshoot problems in movable barrier system 100.

Diagnostic information may be transmitted by movable barrier system 100 to remote device 108. Diagnostic information is the results of diagnostic tests performed by movable barrier system 100 on its various sub-components and externally connected devices. Examples of diagnostic information include a motor load, application voltage, acceleration rate, barrier movement speed, battery voltage, charger status, hold open timer, obstruction sensitivity and fine tune control. This list of diagnostic information, however, should not be interpreted to limit the scope of the present invention.

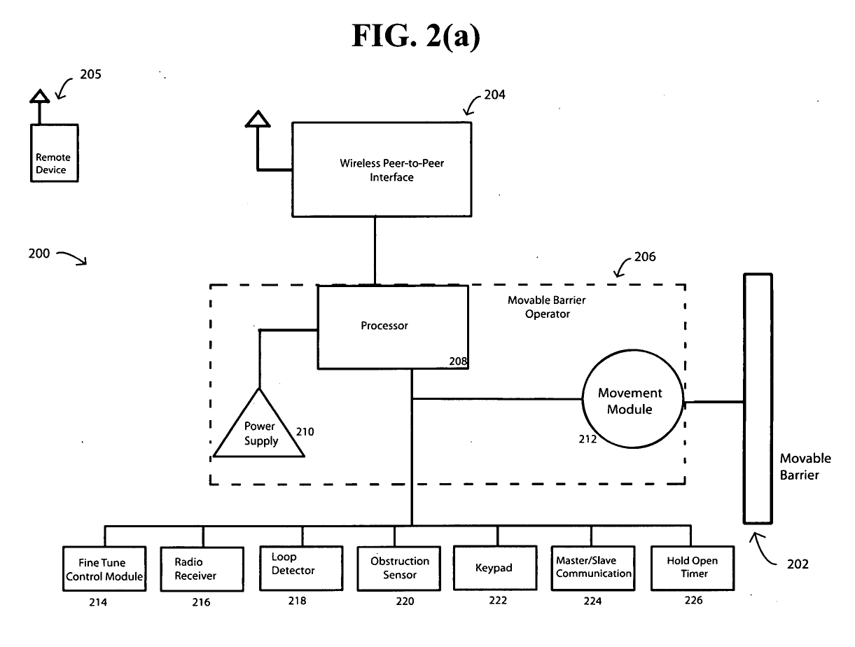

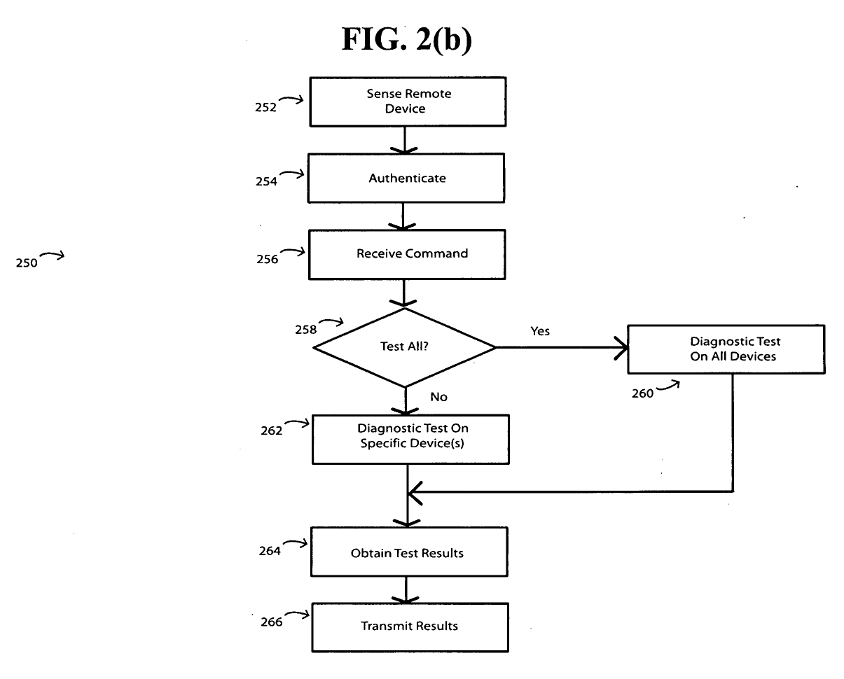

Moving on to the next figure, FIG. 2(a) illustrates a block diagram of an exemplary embodiment of a movable barrier system connected to compatible external devices.

In FIG. 2(a), movable barrier system 200 comprises of movable barrier 202, a wireless peer-to-peer interface 204, and a movable barrier operator 206, which includes processor 208, power supply 210, and movement module 212. Movable barrier system 200 is connected to exemplary compatible external devices including fine tune control module 214, radio receiver 216, loop detector 218, obstruction sensor 220, keypad 222, master/slave communication unit 224, and hold open timer 226. FIG. 2(a) also includes remote device 205.

In order to control movement of movable barrier 202, movable barrier operator 206 should include a power supply, a movement module and a processor. In this embodiment, movable barrier operator 206 is comprised of processor 208, power supply 210, and movement module 212. Movable barrier operator, however, may other internal components and not conflict with the present invention. In the present embodiment, processor 208 is connected to all internal and external components of movable barrier system 200.

Processor 208 governs the functionality of movable barrier system 200 and the interactivity of its sub-components. All data inputs from connected external devices are relayed to processor 208. For example, should radio receiver 216 receive a signal to open movable barrier 202, radio receive 216 would then send a corresponding data input to processor 208. Additionally, command instructions received by wireless peer-to-peer interface 204 are relayed to processor 208.

Processor 208, after receiving data inputs from connected external devices, or command instructions from wireless peer-to-peer interface 204, interprets the data input or command instruction and transmits new instructions to the various sub-components of movable barrier system 200 and its connected external devices. For example, if processor 208 received an open signal from radio receiver 216, processor 208 would then instruct movement module 212 to open movable barrier 202.

In response to a command instruction received by wireless peer-to-peer interface 204, processor 208 may perform diagnostic tests upon the sub-components of movable barrier system 200 and its connected external devices. Processor 208 may also test the functionality of all sub-components of movable barrier system 200 and its connected external devices. Depending upon the command instruction relayed to processor 208 in the transmission received from remote device 205 by wireless peer-to-peer interface 204, processor 208 will either perform specific diagnostic tests, or an entire system diagnostic. For example, should the command instruct movable barrier system 200 to perform a diagnostic test upon power supply 210, processor 208 will only perform a diagnostic test upon power supply 210. Processor 208 will not perform a diagnostic test upon any other sub-component of movable barrier system 200 or its connected external devices. When processor 208 finishes the diagnostic test, processor 208 relays the diagnostic information and test results to wireless peer-to-peer interface 204, which then transmits the test results to remote device 205.

Power supply 210 supplies movable barrier system 200 with power. Power supply 210 may either be a battery or an external source, such as a wall outlet or power circuit connected to an energy grid. Power supply 210 is connected to processor 208. Processor 208 may perform diagnostic tests upon power supply 210 to measure battery voltage, charge status, or some other data information. Power supply 210 may power connected external components to movable barrier system 200.

Engagement of movement module 212 moves movable barrier 202. In the present embodiment, movement module 212 is controlled by processor 208. However, movement module 212 may be engaged by some other means than processor 208 and this embodiment should not limit the scope of the present invention. Movement module 212 may include components such as a motor, an operating shaft, chains, gears, or some other means for moving movable barrier 202. Movement module 212 may open, close, start and stop movement of movable barrier 202. Depending upon the type of movable barrier implemented, movement module 212 may employ different methods for moving movable barrier 202. For example, if movable barrier 202 was an upward swinging door, movement module 212 may swing movable barrier 202 up and down. However, if movable barrier 202 was a horizontally sliding gate, movement module 212 may slide the gate side to side.

Movable barrier system 200 may be connected to one or more compatible external devices. In the embodiment depicted in FIG. 2(a), connected external devices include fine tune control module 214, radio receiver 216, loop detector 218, obstruction sensor 220, keypad 222, master/slave communication unit 224, and hold open timer 226. Note, however, that movable barrier 200 may be connected to fewer or additional compatible external components and should not be interpreted to narrow the scope of the present invention.

A compatible external component is one in which may be connected to and work properly with movable barrier system 200. An external component may be powered by power supply 210. In order to work properly with movable barrier system 200, processor 208 must be able to successfully interpret signals from the external device, and be able to successfully issue instructions to the external device. For example, a garage door sensor would be a compatible externally connected device to movable barrier system 200 if, should there be an object below the garage door, processor 208 receives a signal from said sensor and understands the signal so as to stop the descent of a descending garage door. An incompatible external device to movable barrier system 200 would be, for example, a sensor in which, when it transmits a signal to processor 208, the signal could not be understood by processor 208.

Fine tune control module 214 is an external device that controls the movement limits of movable barrier 202. When movable barrier 202 is reaching the limit of its predetermined track, fine tune control module 214 sends a communication to processor 208 to tell movement module 212 to stop movement.

Radio receiver 216 is an external device in which can receive radio signals from controller devices. An example of a common controller device associated with radio receiver 216 is a garage door opener. When radio receiver 216 receives a signal from a controller device, radio receiver 216 relays the appropriate communication to processor 208. For example, should a user press their garage door opener while approaching the garage, radio receiver 216 will send the communication to processor 208, which instructs movement module 212 to open the garage door.

Other examples of external devices to movable barrier 200 include loop detector 218, obstruction sensor 220, keypad 222 master/slave communication unit 224, and hold open timer 226.

FIG. 2(b) illustrates a flow chart of method 250 employed by movable barrier system 200 to receive command instructions from and transmits diagnostic information and test results to remote device 205, in accordance with one embodiment of the present invention. Method 250 is explained in the order shown below; however, the following steps may be taken in any other conceivable sequence without deviating from the scope of the present invention.

In step 252, the movable barrier system 200 senses remote device 205, a Bluetooth capable device within range. Step 252 requires that movable barrier system 200 be powered and that both the wireless peer-to-peer interface 204 and the movable barrier operator 206 are functioning properly. Typically, step 252 is performed automatically by movable barrier system 200, as the system should continually search for Bluetooth compatible devices within range. However, step 252 may be activated by some other means and should not be interpreted so as to limit the scope of the present invention.

In step 254, movable barrier system 200 authenticates its connection with remote device 205. If remote device 205 has the proper authentication, then movable barrier system 200 connects with remote device 205. In the event that remote device 205 does not have proper authentication, no connection between movable barrier system 200 and remote device 205 will be established. In one exemplary embodiment, remote device 205 has select software installed such that proper authentication may be provided to movable barrier system 200 during authentication. In another exemplary embodiment, owner or operator of movable barrier system 200 may be able to select or set a passkey such that remote device 205 will only be authenticated if selected or set passkey is inputted. If proper connection is established between movable barrier system 200 and remote device 205, movable barrier system 200 proceeds to step 256.

In step 256, movable barrier system 200 waits for a command instruction from remote device 205. If movable barrier system 200 receives a command instruction from remote device 205, movable barrier system 200 proceeds to step 258.

In step 258, movable barrier operator 206 interprets the command instruction sent by remote device 205. If the command instruction requested diagnostic information on all sub-components of movable barrier system 200 and externally connected devices, then movable barrier system proceeds to step 260. For example, if the command instruction was to perform a complete self-diagnostic of all sub-components and externally connected devices, movable barrier system 200 would proceed to step 260. If, however, the command instruction requested diagnostic information on only one or a selection of sub-components of movable barrier system 200 and its externally connected devices, then movable barrier system 200 proceeds to step 262. For example, should the command instruction only request diagnostic information of sub-components of movable barrier system 200, and not the externally connected components, movable barrier system 200 would proceed to step 262.

In step 260, movable barrier system 200 performs a diagnostic test on all sub-components and externally connected devices. In step 262, movable barrier system 200 performs diagnostic tests on select devices requested in the command instruction. Note that the diagnostic test for each sub-component or externally connected device may unique to that particular device. For example, the diagnostic test for power supply 210 may consist of checking the charge status or battery voltage. However, the diagnostic test for sensor 220 may consist of the appliance voltage and obstruction sensitivity or calibration. Diagnostic tests may be performed sequentially or concurrently. The order or concurrence of a diagnostic test should not limit the scope of the present invention.

In step 264, movable barrier system 200 compiles diagnostic test result from the completed diagnostic tests. The test results are interpreted and sorted by processor 208. Each test result and piece of diagnostic information is labeled corresponding to the particular sub-component or external device. For example, a battery voltage for power supply 210 would be labeled as a battery voltage of power supply 210. If, however, a particular diagnostic test could not be completed, the test result would be marked as incomplete.

In step 266, diagnostic information and test results are transmitted to remote device 205. After processor 208 compiles the diagnostic information and test results, it relays the information to wireless peer-to-peer interface 204. For example, if the command instruction were to perform a diagnostic test on all sub-components of movable barrier system 200, and the test was successfully completed, wireless peer-to-peer interface 204 would transmit to remote device 205 the compiled test results for every sub-component of movable barrier system 200. If, however, the test was not successful, wireless peer-to-peer interface 204 would transmit to remote device 205 the partially completed test results in addition to a list of incomplete tests and their corresponding sub-components.

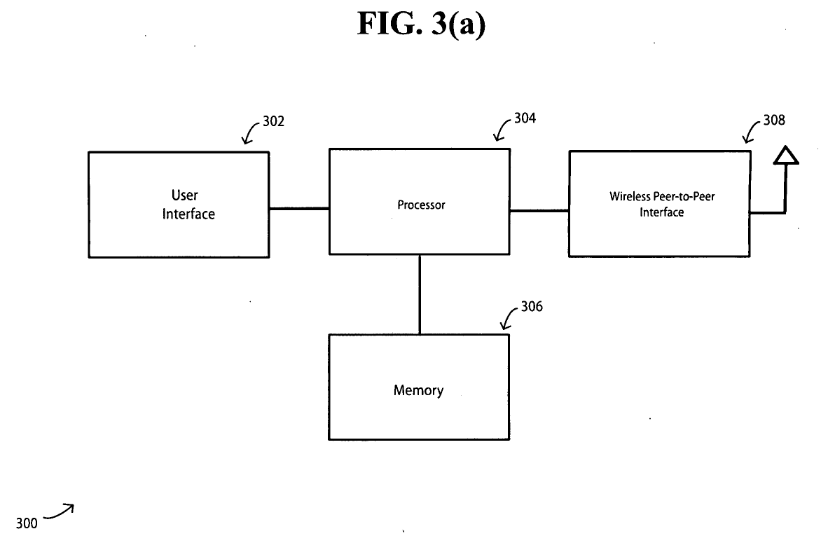

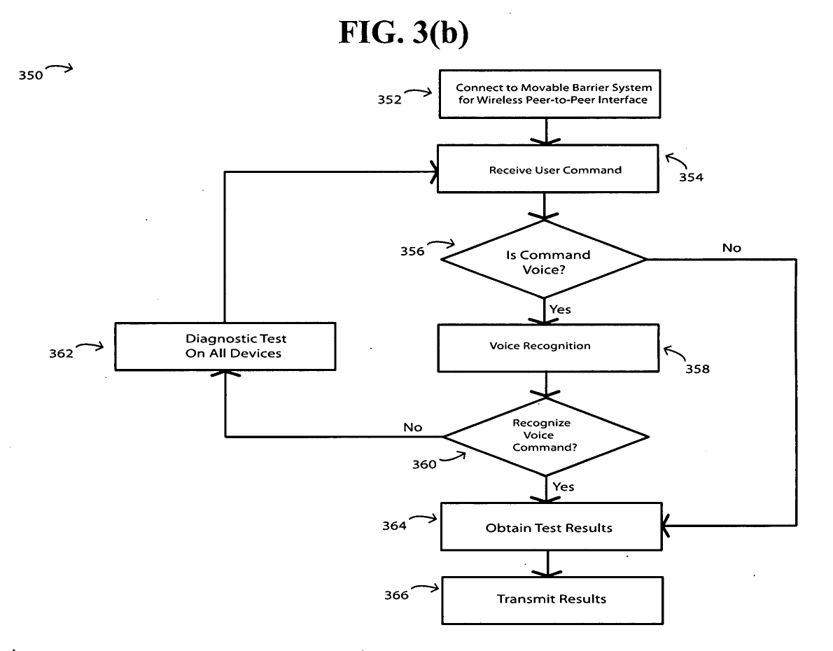

FIG. 3(a) illustrates a block diagram of an exemplary embodiment of the internal components of a remote device. In FIG. 3(a), remote device 300 comprises a user interface 302, processor 304, memory 306, and wireless peer-to-peer interface 308.

Remote device 300 may be any device that is Bluetooth enabled. Examples of such devices include cell phones, Bluetooth enabled earpieces, personal digital assistants, and notebook computers. As discussed in FIG. 1 and FIG. 2, remote device 300 may transmit command instructions to a movable barrier system and may also receive diagnostic information and test results from said movable barrier system.

User interface 302 includes means for user input. A user of remote device 300 need be able to input a desired command instruction into user interface 302, and remote device 300 then need be able to relay subsequent diagnostic results to said user. Such examples of a user input for user interface 302 include a keyboard, a microphone, or a touch screen. For example, if user interface 302 included a microphone input, the user could speak diagnostic test instructions into the microphone. However, if user interface 302 included a keyboard input, the user could type in diagnostic tests desired.

User interface 302 also includes means for information output to user. Examples of an information output for user interface 302 include a text or graphical screen, or a text-to-speech audible mechanism. For example, if user interface 302 included a text-to-speech audible mechanism as the output, user interface 302 may output the diagnostic information and test results to user via audible speech. However, if user interface 302 included a text screen or monitor as the output, user interface 302 would print out diagnostic test results on the text screen.

Processor 304 controls the functionality of remote device 300 and its sub-components. Memory 306 is utilized by processor 304 to store information and to interpret and translate data for various sub-components of remote device 300. For example, should user input a command instruction into user interface 302, processor 304 interprets and translates said command instruction, utilizing memory 306, in order to relay command instruction to wireless peer-to-peer interface 308 for transmission to the movable barrier system. If wireless peer-to-peer interface 308 receives diagnostic information and test results from the movable barrier system, the information is interpreted and translated by processor 304 such that it may be outputted by user interface 302.

Processor 304 and memory 306 also translate information based upon the methods of input and output utilized in user interface 302. For example, should the diagnostic information and test results need to be outputted textually on screen, processor 304 may convert the results into a format such that user interface 302 may display the information on screen. However, should the user interface require that the information be audibly read through a text-to-speech mechanism, processor 304 and memory 306 would utilize the text-to-speech mechanism, converting said diagnostic information and test results into data such that user interface 302 may create audible speech to be outputted to user.

Wireless peer-to-peer interface 308 is another internal component of remote device 300 controlled by processor 304. Wireless peer-to-peer interface 308 may transmit command instructions to a movable barrier system. Wireless peer-to-peer interface 308 may also receive diagnostic information and test results from a movable barrier system. For example, should user input a command instruction into user interface 302, processor 304 would instruct wireless peer-to-peer interface 308 to transmit said command instruction to the movable barrier system. Should the movable barrier system transmit diagnostic information and test results to remote device 300, wireless peer-to-peer interface 308 would receive said diagnostic information and test results and relay them to processor 304 for output by user interface 302.

FIG. 3(b) illustrates a flow chart of method 350 employed by remote device 300 to transmit command instructions to, and retrieve diagnostic information from, a movable barrier system in one embodiment of the present invention. Method 350 is explained in the order shown below; however, the following steps may be taken in any other conceivable sequence without deviating from the scope of the present invention.

In step 352, remote device 300 connects to movable barrier system. In order for remote device 300 to connect to a movable barrier system, remote device 300 must be within wireless peer-to-peer range of a movable barrier system, and wireless peer-to-peer interface 308 must establish connection with movable barrier system. Additionally, remote device 300 must have proper authentication to establish connection with movable barrier system, otherwise movable barrier system will refuse to connect to remote device 300.

In step 354, user inputs a command instruction into remote device 300. User inputs a command instruction into remote device 300 via user interface 302, as described previously for FIG. 3(a).

In step 356, processor 304 interprets the command instruction inputted in step 354. If the command instruction was voice, remote device 300 proceeds to step 358. If, however, the command instruction was inputted through keyboard or touch screen, for example, remote device 300 proceeds to step 364. For example, should user speak the command instructions into user interface 302, remote device 300 would next proceed to step 358 for voice recognition processing. However, if the user simply keyed in or selected a desired command instruction via user interface 302, remote device 300 would proceed to step 364 for transmission of command instruction to movable barrier system.

In step 358, processor 304, utilizing memory 306, performs voice recognition processing on the inputted command instruction via user interface 302. Step 358 is only performed if the user speaks the command instruction into remote device 300 and remote device 300 has voice input capability. After processor 304 performs voice recognition on the command instruction by translating the inputted command into useful data, remote device 300 proceeds to step 360.

In step 360, processor 304 compares the translated command data to possible command instructions that may be transmitted to movable barrier system. If processor 304 recognizes the translated command, then the command then may be transmitted to movable barrier system via wireless peer-to-peer interface 308 and remote device 300 proceeds to step 364. For example, should a user speak into remote device 300 a request for a diagnostic test on all sub-components of the movable barrier system, and processor 304 translates and understands the user input, remote device 300 then proceeds to step 364, because a complete diagnostic test on all sub-components of movable barrier system is possible. However, if processor 304 does not recognize the translated command, or the translated command requests a diagnostic test that is not possible, remote device 300 proceeds to step 362. For example, should user input a command instruction requesting a diagnostic test on all externally connected devices to movable barrier system, but no external devices are connected, then remote device 300 proceeds to step 362.

In step 362, remote device 300 prompts user via user interface 302 that the voice input was unintelligible or impossible, and that user input needs to be repeated. Remote device 300 then proceeds back to step 354.

Prior to step 364, connection by remote device 300 to movable barrier system should be established. In method 350, connection between remote device 300 and movable barrier system is established at step 352, however, in other embodiments of the present invention connection may be established at another time prior to step 364.

In step 364, remote device 300 transmits the command instruction to the movable barrier system. To transmit the command instruction to the movable barrier system, processor 304 instructs wireless peer-to-peer interface 308 to transmit the command instruction to movable barrier system. Processor 304 relays the interpreted and translated command instruction to wireless peer-to-peer interface 308. Wireless peer-to-peer interface 308, upon receiving the translated command instruction, transmits the command instruction to movable barrier system.

After transmission of command instructions to movable barrier system, remote device 300 waits for transmission of diagnostic information and test results from movable barrier system. In step 366, remote device 300 receives diagnostic information and test results from movable barrier system. When wireless peer-to-peer interface 308 receives transmitted diagnostic information and test result data from the movable barrier system, it relays the data to processor 304. Processor 304 then, utilizing memory 306, translates the received data from movable barrier system and relays the information to user interface 302 for output to user.

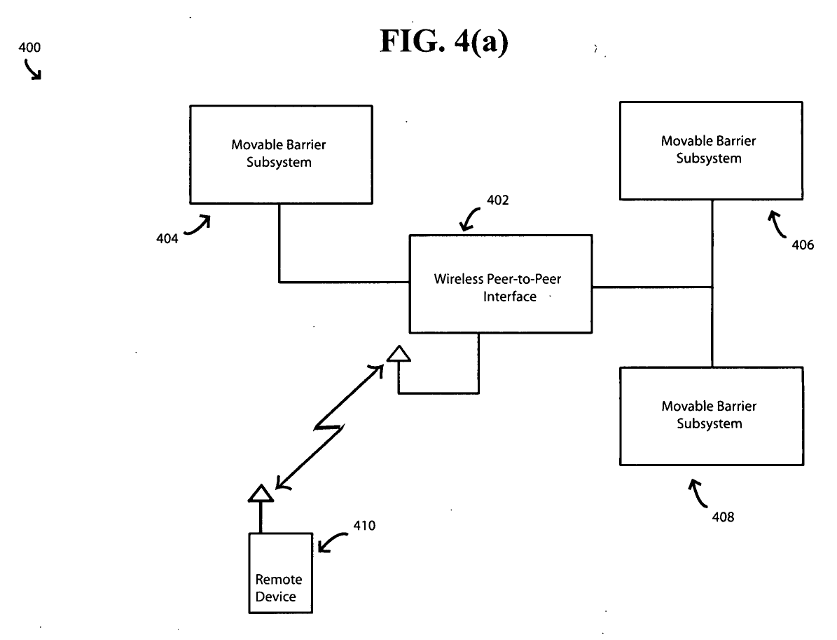

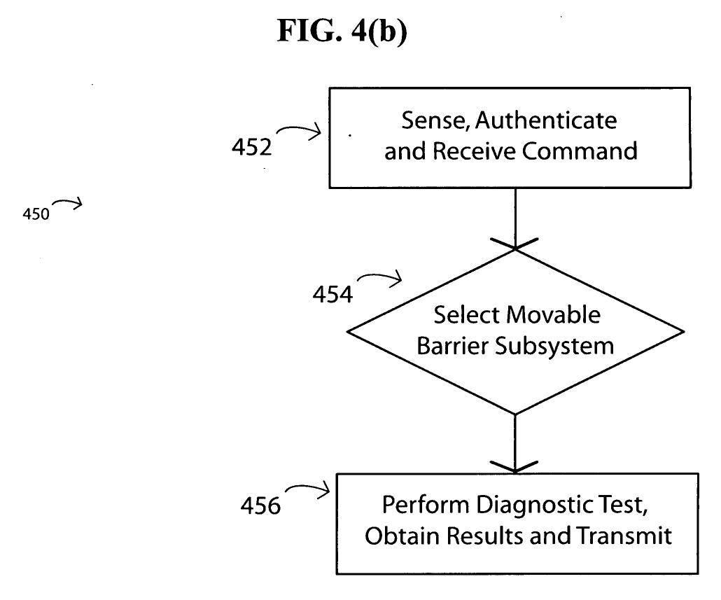

FIG. 4(a) illustrates a block diagram of an exemplary embodiment of a plurality of movable barrier subsystems and a wireless peer-to-peer interface adapted to transmit diagnostic information to a remote device in response to a control instruction received from the remote device.

FIG. 4(a) illustrates movable barrier system plurality 400 comprising a wireless peer-to-peer interface 402, movable barrier subsystem 404, movable barrier subsystem 406 and movable barrier subsystem 408. Movable barrier system plurality 400 wirelessly connects to remote device 410 via Bluetooth protocol through wireless peer-to-peer interface 402.

Movable barrier system plurality 400 is a set of movable barrier subsystems interconnected to work in conjunction or individually. Movable barrier subsystems comprise a movable barrier and a movable barrier operator. In FIG. 4(a), subsystems 402, 404 and 406 all share wireless peer-to-peer interface 408. However, FIG. 4(a) should not be interpreted as to limit the scope of the present invention. Each movable barrier subsystem may have its own movable barrier operator, movable barrier or wireless peer-to-peer interface. In other embodiments, however, movable barrier subsystem may share one or more components with other movable barrier subsystems.

A plurality of interconnected movable barrier systems has many practical real-world applications. For example, many commercial garages employ a series of movable barriers. While each movable barrier system in the commercial garage could be controlled individually, it would increase utility for the garage operator to be able to control each movable barrier both individually or simultaneously. Furthermore, utility for the garage operator would increase if the plurality of movable barriers could be accessed both individually and simultaneously for diagnostic maintenance and repair. Therefore, it would be logical in the present example for the gate operator to interlink the plurality of movable barriers into movable barrier system plurality, and thus be accessible and controllable by remote device 410 for diagnostics and repair, as illustrated in FIG. 4(a).

FIG. 4(b) illustrates a flow chart of a method 450 employed by movable barrier system plurality 400 to receive and perform diagnostic instructions from, and transmits diagnostic results to remote device 410, in accordance with one embodiment of the present invention. Method 450 is the same as method 250 as described in FIG. 2(b), with the addition of single step employed by movable barrier system plurality 400. Method 450 is explained in the order shown below; however, the following steps may be taken in any other conceivable sequence without deviating from the scope of the present invention.

In step 452, movable barrier system plurality 400 senses, authenticates, and receives command instructions from remote device 410. Detailed explanation of sensing, authentication, and reception of command instruction by movable barrier system plurality 400 in step 452 was discussed previously. After command instructions are received, movable barrier system plurality 400 proceeds to step 454.

In step 454, movable barrier system plurality 400 selects the applicable movable barrier subsystem in which to perform diagnostic tests. For example, if the command instructions stated to perform a complete diagnostic on movable barrier subsystem 404, only diagnostic tests would be performed on movable barrier subsystem 404. However, if the command instruction stated to perform diagnostic tests on all movable barrier subsystems, then diagnostic tests would be performed on movable barrier subsystems 404, 406 and 408. After the applicable movable barrier subsystems are selected, movable barrier system plurality 400 proceeds to step 454.

In step 454, diagnostic tests are performed on movable barrier subsystems specified in the command instructions. After obtaining test results, movable barrier system plurality 400 then transmits the diagnostic information and test results to remote device 410. Detailed explanation of the performance of diagnostic tests and transmission of diagnostic information and test results by movable barrier system plurality 400 in step 454 was discussed previously.

A movable barrier system adapted to transmit diagnostic information to a remote device has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. A movable barrier system comprising:
a movable barrier;
an operator adapted to control movement of the movable barrier; and
a wireless peer-to-peer interface adapted to transmit diagnostic information to a remote device in response to a command instruction received from the remote device.

2. The system of claim 1, wherein said wireless peer-to-peer interface further comprises a Bluetooth device.

3. The system of claim 1, wherein said operator may perform a diagnostic test on one or more of the following devices:
a power supply;
a movement module;
a loop detector;
a radio receiver;
an exit device;
a master/slave communication;
a hold open timer;
an overlap delay;
an obstruction sensor; and
a fine tune control module.

4. The system of claim 1, wherein said operator may perform a self-diagnostic test.

5. The system of claim 1, wherein said diagnostic information further comprises one or more of the following:
a motor load;
an acceleration rate;
a barrier movement speed;
an appliance voltage;
a battery voltage;
a charger status;
an operator status;
a hold open timer;
an obstruction sensitivity; and
a fine tune control.

6. The system of claim 1, wherein said remote device comprise a Bluetooth enabled device.

7. The system of claim 6, wherein said Bluetooth enabled device comprises a cell phone or a personal digital assistant.

8. The system of claim 6, wherein the wireless peer-to-peer interface is adapted to receive another control instruction from said remote device for instructing said movable barrier to:
open;
close; and
stop.

9. The system of claim 1, wherein the wireless peer-to-peer interface is adapted to receive another control instruction from said remote device for changing a parameter for one or more of the following devices:
a loop detector;
a radio receiver;
an exit device;
a master/slave communication; and
a hold open timer;
an overlap delay;
an obstruction sensor; and
a fine tune control module.

10. The system of claim 1, wherein the wireless peer-to-peer interface is adapted to receive another control instruction for changing a parameter related to:
a motor load;
an acceleration rate;
a barrier movement speed;
an appliance voltage;
a battery voltage;
a charger status.
a hold open timer;
an obstruction sensitivity;
a fine tune control; and
other modes of operation.

11. A movable barrier system, comprising:
a plurality of movable barrier subsystems; and
a wireless peer-to-peer interface adapted to transmit diagnostic information from at least one of the movable barrier subsystems to a remote device in response to a control instruction received from said remote device.

12. The system of claim 11, wherein said movable barrier subsystem comprises a movable barrier and a movable barrier operator.

13. The system of claim 11, wherein said wireless peer-to-peer interface further comprises a Bluetooth device.

14. The system of claim 11, wherein said movable barrier subsystems perform a diagnostic test on one or more of the following devices:
a power supply;
a movement module;
a loop detector;
a radio receiver;
an exit device;
a master/slave communication;
a hold open timer;
an overlap delay;
an obstruction sensor; and
a fine tune control module.

15. The system of claim 11, wherein said diagnostic information further comprises one or more of the following:
a motor load;
an acceleration rate;
a barrier movement speed;
an appliance voltage;
a battery voltage;
a charger status;
a hold open timer;
an obstruction sensitivity; and
a fine tune control.

16. The system of claim 11, wherein said remote device comprise a Bluetooth enabled device.

17. The system of claim 11, wherein said control instruction from said remote device comprises instructing said movable barrier to:
open;
close; and
stop.

18. A wireless remote device, comprising:
a user interface;
a wireless peer-to-peer interface;
a processor adapted to:
(a) receive a first command from a user via the user interface;
(b) transmit a second command to a movable barrier system via the wireless peer-to-peer interface; and
(c) receive diagnostic information from the movable barrier system via the wireless peer-to-peer interface.

19. The wireless remote device of claim 18, wherein said wireless peer-to-peer interface comprises a Bluetooth enabled interface.

20. The wireless remote device of claim 18, wherein the first command comprises a voice command.

21. The wireless remote device of claim 20, wherein the processor is adapted to implement voice or speech recognition.

22. The wireless remote device of claim 18, wherein the user interface includes a visual display adapted to show diagnostic information.

23. The wireless remote device of claim 18, wherein the wireless remote device may be plugged into the movable barrier system.

24. The wireless remote device of claim 18, wherein the processor is adapted to perform speech synthesis on diagnostic information received for the purpose of providing audible speech output of diagnostic information to user.

25. The wireless remote device of claim 18, wherein said device may transfer diagnostic information results to a third party.

26. A method for transmitting diagnostic information, comprising the steps of:
receiving a command from a wireless peer-to-peer interface in a wireless peer-to-peer protocol, in response to the command performing one or more diagnostic tests on one or more diagnostic elements of a movable barrier system, and
transmitting information relating to the one or more diagnostic tests in the wireless peer-to-peer protocol.
